(19) United States
(12) Patent Application Publication
(10) Pub. No.: US 2015/0006667 A1
(43) Pub. Date: Jan. 1, 2015

(54) DYNAMIC DATA COMPRESSION SYSTEM

(71) Applicants: Jeffrey R. FOERSTER, Portland, OR (US); Jaideep MOSES, Portland, OR (US); Geoff O. WEAVER, Portland, OR (US); Anthony G. LAMARCA, Seattle, WA (US); Xue YANG, Arcadia, CA (US); Kerstin JOHNSSON, Palo Alto, CA (US); Wen-Ling M. HUANG, Los Altos, CA (US); Rahul C. SHAH, San Francisco, CA (US); Harry G. SKINNER, Beverton, OR (US)

(72) Inventors: Jeffrey R. FOERSTER, Portland, OR (US); Jaideep MOSES, Portland, OR (US); Geoff O. WEAVER, Portland, OR (US); Anthony G. LAMARCA, Seattle, WA (US); Xue YANG, Arcadia, CA (US); Kerstin JOHNSSON, Palo Alto, CA (US); Wen-Ling M. HUANG, Los Altos, CA (US); Rahul C. SHAH, San Francisco, CA (US); Harry G. SKINNER, Beverton, OR (US)

(21) Appl. No.: 13/930,134

(22) Filed: Jun. 28, 2013

(51) Int. Cl. H04L 29/08

(52) U.S. Cl. CPC H04L 67/32
USPC 709/217

(57) ABSTRACT

This disclosure is directed to a dynamic data compression system. A device may request data comprising certain content from a remote resource. The remote resource may determine if any part of the content is identical or similar to content in other data and if the other data is already on the requesting device. Smart compression may then involve transmitting only the portions of the content not residing on the requesting device, which may combine the received portions of the content with the other data. In another example, a capturing device may capture at least one of an image or video. Smart compression may then involve transmitting only certain features of the image/video to the remote resource. The remote resource may determine image/video content based on the received features, and may perform an action based on the content. In addition, a determination whether to perform smart compression may be based on system/device conditions.

### TECHNICAL FIELD

The present disclosure relates to data compression, and more particularly, to a system for dynamically compressing data based on analyzing the data content and/or participating devices.

### BACKGROUND

Modern computing technology is increasingly becoming reliant upon communications for basic operation. In addition to the communication-related functionality that is typically included in mobile devices (e.g., voice/text communication, media, streaming, etc.), this trend is at least in part due to the general architecture utilized in modern computing devices becoming less device-centric. In a previous example of operation, physical media was employed to install applications configured to execute locally (e.g., in an offline mode). Sometimes the local applications would need to access an online resource. While this type of operation may still be employed, emerging computing devices are quickly moving towards an always-connected mode of operation. Some or all of the programmatic elements making up the applications executed by the new computing devices may now be located remotely. In one example implementation, “cloud”-based resources may comprise at least one computing device accessible via a wide-area network (WAN). Parts of applications may be stored in the cloud (e.g., databases, models, etc.) so that information may be available in real-time, while also reducing the processing load of the local computing device.

While always-on architectures may satisfy user desires from a performance perspective, increasing the communication load introduces a myriad of other problems. At the device level, increased communication requirements may result in more data being transmitted and received, which puts more strain on the processing, communication and energy resources of devices. The additional loading is most problematic for computing devices that rely substantially on wireless communication (e.g., smart phones). Moreover, the wired/wireless communication mediums on which these devices rely are being taxed by the additional communication requirements. More users are utilizing more devices with higher communication demands. As a result, traffic is increasing, and management of the increased traffic will be an issue for the foreseeable future.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example dynamic data compression system in accordance with at least one embodiment of the present disclosure;

FIG. 2 illustrates an example configuration for a device usable in a dynamic data compression system in accordance with at least one embodiment of the present disclosure;

FIG. 3 illustrates an example configuration for remote resources in accordance with at least one embodiment of the present disclosure;

FIG. 4 illustrates an example of smart compression based on content recycling in accordance with at least one embodiment of the present disclosure;

FIG. 5 illustrates an example of smart compression based on feature identification in accordance with at least one embodiment of the present disclosure;

FIG. 6 illustrates example operations for a dynamic data compression system based on content recycling in accordance with at least one embodiment of the present disclosure; and

FIG. 7 illustrates example operations for a dynamic data compression system based on feature identification in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to a dynamic data compression system. A device may interact with a remote resource such as at least one cloud-based computing device. In a first example of operation, the device may request data comprising certain content from the remote resource. The remote resource may determine if any part of the requested content is identical or similar to content in other data, and if identical or similar content exists, if the identical or similar content is already on the requesting device. If other data with identical or similar content is determined to be on the requesting device, smart compression may be performed by transmitting only the portions of the requested content not already residing on the requesting device. During decompression the requesting device may then combine the portions of the content received from the remote resource with the content already existing on the device. In another example of smart compression, a device may capture at least one of an image or video, and may perform smart compression by transmitting only certain features of the image or video to the remote resource. The remote resource may then perform decompression by determining the content of the image based on the features, and may perform an action based on the determined content (e.g., may transmit information to the capturing device). In addition, a determination whether to perform smart compression may be based on system/device conditions.

In one embodiment, at least one device may comprise, for example, a content analytics module, a device analytics module, a smart compression/decompression (codec) module and a communication module. The content analytics module may be to receive a request for data including certain content from a device and to analyze the content of the data. The device analytics module may be to analyze characteristics of the requesting device based at least on the content analysis performed by the content analytics module. The smart codec module may be to at least compress the data based at least on the analysis performed by the client analytics module. The communication module may be to transmit the compressed data to the requesting device.

In an example implementation consistent with the present disclosure, the at least one device may comprise a plurality of computing devices to operate as a cloud resource accessible via a wide area network (WAN). The content analytics module being to analyze the content of the data requested by the device may comprise, for example, the content analytics module being to determine if any portion of the content is identical or similar to any portion of content in other data. The device analytics module being to analyze the characteristics of the requesting device may comprise, for example, the device analytics module being to, if it is determined that a portion of the content is identical or similar to any portion of content in other data, determine if the requesting device is able to support smart compression. Determining if the requesting device is able to perform smart compression may comprise, for example, the device analytics module being to determine at least one of capability or condition for the requesting device. The device analytics module being to analyze the characteristics of the requesting device may comprise, for example, the device analytics module being to determine if the other data determined to contain any portion of identical or similar content is already present on the requesting device. The smart codec module being to at least compress the data may comprise, for example, the smart codec module being to remove any portion of content from the data that was determined to be identical or similar to any portion of content in the other data determined to be already present in the requesting device. In another example implementation, the smart codec module being to at least compress the data may comprise, for example, the smart codec module being to generate change information allowing the requesting device to alter the content of the other data determined to be already present in the requesting device to be identical or similar to the content of the data.

In one embodiment, the smart codec may further be to receive compressed data from a capturing device, the compressed data including features derived from at least one of images or video captured by the capturing device. The smart codec may further be to determine content for the at least one of images or video based on the features. In the same or a different embodiment the at least one device may further comprise an augmented reality module to provide context information to the capturing device based on the content. An example method consistent with the present disclosure may comprise receiving a request for data including certain content from a device, performing analysis on the content of the data, performing analysis on the requesting device based at least on the content analysis, determining whether to use smart compression based at least on the device analysis, compressing the data based on at least on the determination whether to use smart compression and the device analysis and transmitting the compressed data to the requesting device.

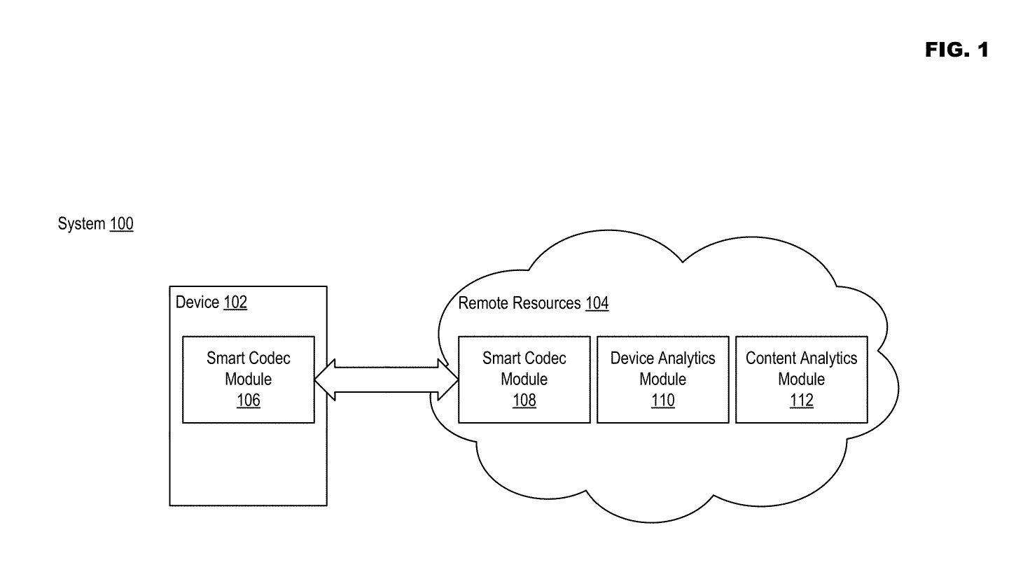

FIG. 1 illustrates an example dynamic data compression system in accordance with at least one embodiment of the present disclosure. System 100 may comprise, for example, device 102 and remote resources 104. Examples of device 102 may include, but are not limited to, a mobile communication device such as a cellular handset or a smartphone based on the Android® operating system (OS), iOS®, Windows® OS, Blackberry® OS, Palm® OS, Symbian® OS, etc., a mobile computing device such as a tablet computer like an iPad®, Surface®, Galaxy Tab®, Kindle Fire®, etc., an Ultrabook® including a low-power chipset manufactured by Intel Corporation, a netbook, a notebook, a laptop, a palmtop, etc., a stationary computing device such as a desktop computer, a set-top device, a smart television (TV), etc. Remote resources 104 may include at least one computing device accessible via wired and/or wireless communication. In an example implementation, remote resources 104 may be a cloud computing solution including a plurality of computing devices (e.g., servers) accessible through a WAN such as the Internet.

Device 102 may interact with remote resource 104 via wired/wireless communication. In one example of operation, device 102 may transmit a request for content (e.g., for data including certain content) to remote resources 104, to which remote resources 104 may respond with the requested content. It may also be possible for device 102 may also provide remote resources 104 with image and/or video information, to which remote resources 104 may respond with context information pertaining the image and/or video information. While these examples of operation are discussed in detail in this disclosure, they are presented only for the sake of explanation and are not intended to limit the applicability of embodiments consistent with the present disclosure. In particular, embodiments consistent with the present disclosure may be applied in any situation where data compression would be advantageous for the transmission of data between devices.

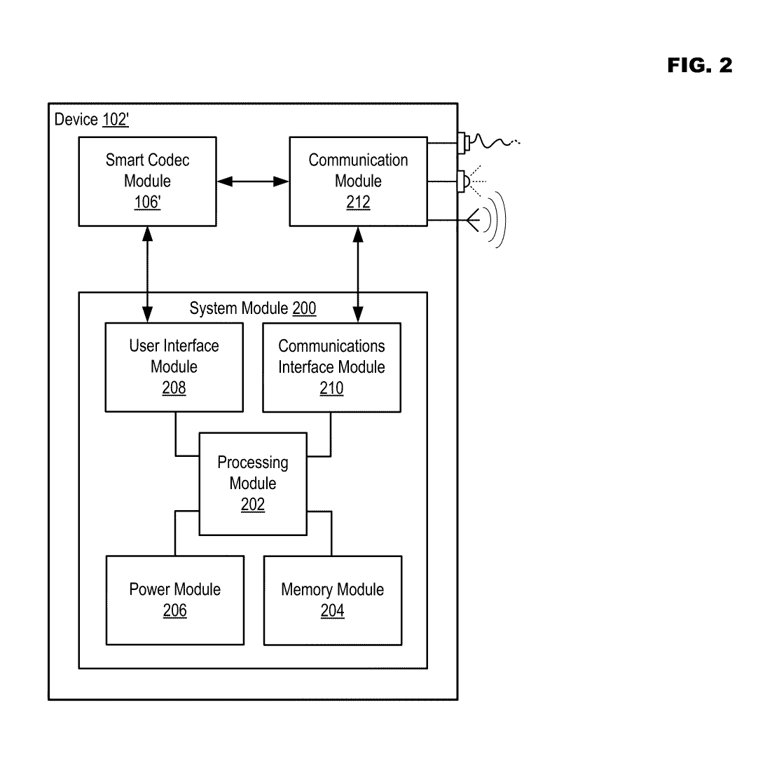

In one embodiment, device 102 may comprise, for example, a smart codec module 106. A smart codec module may comprise, for example, a codec with enhanced compression features such as will be described in regard to FIG. 2-7. These enhanced compression features may allow device 102 to perform data compression at a substantially higher ratio when compared to existing systems. Remote resources 104 may comprise a similar smart codec module 108. Smart codec module 108 may be compatible with smart codec module 106 in that the data compressed by smart codec module 108 may be decompressed by smart codec module 106, and vice-versa. Remote resources 104 may also comprise device analytics module 110 and content analytics module 112. Device analytics module 110 may be to determine characteristics about device 102 that may be relevant to smart compression. Examples of characteristics may include, but are not limited to, a determination of content already stored on device 102, the capability of device 102 (e.g., whether smart compression is supported by device 102) and the condition of device 102 (e.g., current processing load, communication load, power level, etc.). Content analytics module 112 may be to determine other data (e.g., other than the data being requested) having portions of content identical or similar to portions of content in the data being requested by device 102. For example, other data already stored in device 102 and including identical or similar portions of content may be used to reduce the amount of data to be transmitted to device 102, thereby increasing compression. In the instance where the portions of content are similar, some modification may be performed by device 102 to make the portions of content identical.

FIG. 2 illustrates an example configuration for a device usable in a dynamic data compression system in accordance with at least one embodiment of the present disclosure. In particular, while device 102′ may perform example functionality such as disclosed in FIG. 1, device 102′ is meant only as an example of equipment that may be used in accordance with embodiments consistent with the present disclosure, and is not meant to limit these various embodiments to any particular manner of implementation.

Device 102′ may comprise system module 200 configured to manage device operations. System module 200 may include, for example, processing module 202, memory module 204, power module 206, user interface module 208 and communication interface module 210 that may be configured to interact with communication module 212. Device 102′ may also include smart codec module 106′ configured to interact with at least user interface module 208 and communication module 212. While communication module 212 and smart codec module 106′ are illustrated as separate from system module 200, this is merely for the sake of explanation herein. Some or all of the functionality associated with communication module 212 and/or smart codec module 106′ may also be incorporated within system module 200.

In device 102′, processing module 202 may comprise one or more processors situated in separate components, or alternatively, may comprise one or more processing cores embodied in a single component (e.g., in a System-on-a-Chip (SoC) configuration) and any processor-related support circuitry (e.g., bridging interfaces, etc.). Example processors may include, but are not limited to, various x86-based microprocessors available from the Intel Corporation including those in the Pentium, Xeon, Itanium, Celeron, Atom, Core i-series product families, Advanced RISC (e.g., Reduced Instruction Set Computing) Machine or “ARM” processors, etc. Examples of support circuitry may include chipsets (e.g., Northbridge, Southbridge, etc. available from the Intel Corporation) configured to provide an interface through which processing module 202 may interact with other system components that may be operating at different speeds, on different buses, etc. in device 102′. Some or all of the functionality commonly associated with the support circuitry may also be included in the same physical package as a microprocessor (e.g., in an SoC package like the Sandy Bridge integrated circuit available from the Intel Corporation).

Processing module 202 may be configured to execute various instructions in device 102′. Instructions may include program code configured to cause processing module 202 to perform activities related to reading data, writing data, processing data, formulating data, converting data, transforming data, etc. Information (e.g., instructions, data, etc.) may be stored in memory module 204. Memory module 204 may comprise random access memory (RAM) and/or read-only memory (ROM) in a fixed or removable format. RAM may include memory configured to hold information during the operation of device 102′ such as, for example, static RAM (SRAM) or Dynamic RAM (DRAM). ROM may include memories such as bios memory configured to provide instructions when device 102′ activates in the form of bios, Unified Extensible Firmware Interface (UEFI), etc., programmable memories such as electronic programmable ROMs (EPROMS), Flash, etc. Other fixed and/or removable memory may include magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), etc. Power module 206 may include internal power sources (e.g., a battery) and/or external power sources (e.g., electromechanical or solar generator, power grid, fuel cell, etc.), and related circuitry configured to supply device 102′ with the power needed to operate.

User interface module 208 may include circuitry configured to allow users to interact with device 102′ such as, for example, various input mechanisms (e.g., microphones, switches, buttons, knobs, keyboards, speakers, touch-sensitive surfaces, one or more sensors configured to capture images and/or sense proximity, distance, motion, gestures, etc.) and output mechanisms (e.g., speakers, displays, lighted/flashing indicators, electromechanical components for vibration, motion, etc.). Communication interface module 210 may be configured to handle packet routing and other control functions for communication module 212, which may include resources configured to support wired and/or wireless communications. Wired communications may include serial and parallel wired mediums such as, for example, Ethernet, Universal Serial Bus (USB), Firewire, Digital Visual Interface (DVI), High-Definition Multimedia Interface (HDMI), etc. Wireless communications may include, for example, close-proximity wireless mediums (e.g., radio frequency (RF) such as based on the Near Field Communications (NFC) standard, infrared (IR), optical character recognition (OCR), magnetic character sensing, etc.), short-range wireless mediums (e.g., Bluetooth, wireless local area networking (WLAN), Wi-Fi, etc.) and long range wireless mediums (e.g., cellular wide area radio communication technology that may include, for example, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard). In one embodiment, communication interface module 210 may be configured to prevent wireless communications that are active in communication module 212 from interfering with each other. In performing this function, communication interface module 210 may schedule activities for communication module 212 based on, for example, the relative priority of messages awaiting transmission.

In the embodiment illustrated in FIG. 2, smart codec module 106′ may interact with at least user interface module 208 and communication module 212. For example, smart codec module 106′ may receive compressed data from communication module 212, may decompress the compressed data and then provide the decompressed data to user interface module 208 for presentation (e.g., displaying images/video, generating sound, etc.). In another example of operation, smart code module 106′ may receive data (e.g., at least one of captured image or video data) from user interface module 208, may compress the data and may then provide the compressed data to communication module 212 for transmission (e.g., to remote resources 104).

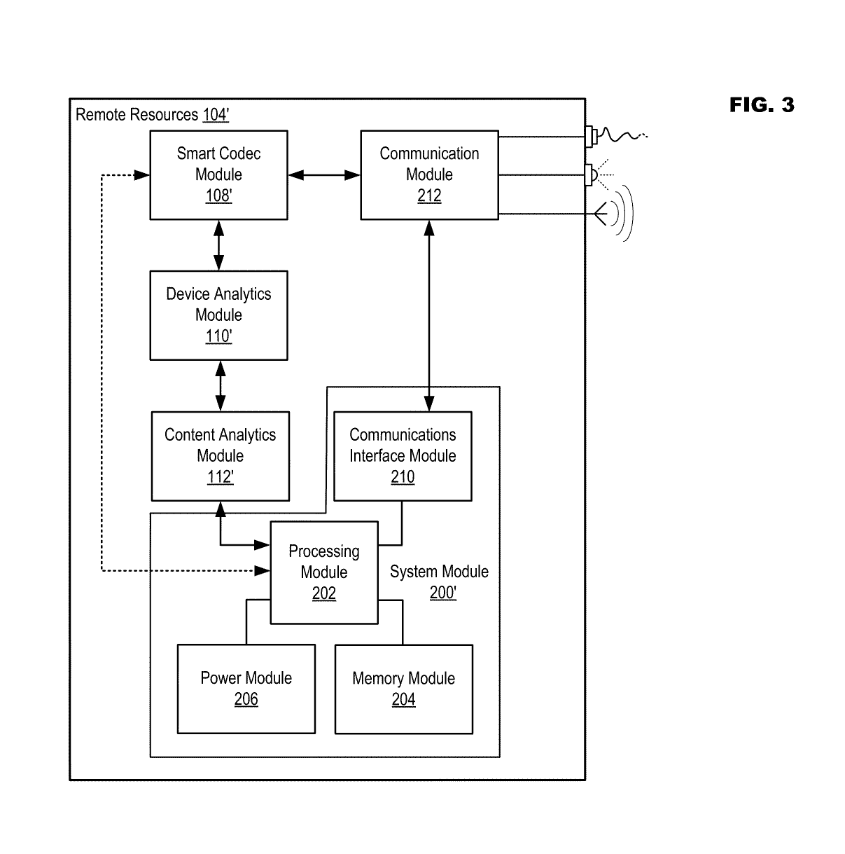

FIG. 3 illustrates an example configuration for remote resources in accordance with at least one embodiment of the present disclosure. Initially, while remote resources 104′ have been represented as a single device, it is also possible for remote resources 104′ to comprise more than one device. For example, remote resource may include a plurality of devices configured to collaborate. The plurality of devices may be networked servers accessible via a WAN like the Internet (e.g., as a cloud-based resource), and may be configured to operate in a similar manner or may be more specialized with each of the plurality of devices performing different functions.

System module 200′ may comprise processing module 202, memory module 204, power module 206 and communications interface module 210 to interact with communication module 212. These modules may operate in a manner similar to that already disclosed in regard to FIG. 2. User interface module 208 has been omitted from system module 200′, and may be optional depending on the configuration of remote resources 104′. For example, if remote resources 104′ comprises a plurality of servers clustered in a rack, then it may be unnecessary for each server to include user interface resources (e.g., one device may serve as an interface to many servers).

Remote resource 104′ may further comprise smart codec 108′, device analytics module 110′ and content analytics module 112′. Smart codec 108′ may interact with at least device analytics module 110′ and communications module 212. For example, smart codec 108′ may receive data comprising certain content requested by device 102, may compress the data and then may provide the compressed data to communication module 212 for transmission to device 102. Device analytics modules 110′ may interact with at least smart codec 108′ and content analytics module 112′. For example, device analytics module 110′ may receive at least an identification of other data including portions of content identical or similar to portions of the content of data requested by device 102 from content analytics module 112′, may determine if any of the other data is already stored in device 102 and may provide data for compression to smart codec module 108′ based on the identification of the other data already stored in device 102. Content analytics module 112′ may interact with at least content analytics module 112′ and processing module 202. For example, content analytics module may use processing module 202 to determine any other data having portions of content identical or similar to portions of content in data being requested by device 102, and may provide an identification of the other data to device analytics module 110′.

In one embodiment, smart codec module 108′ may also interact directly with processing module 202. For example, smart codec module 108′ may receive compressed data from device 102 and may proceed to decompress the compressed data. The decompressed data may include, for example, features corresponding to data captured by device 102. Processing module 102 may be utilized to determine content corresponding to the captured data based on the features, and further to generate a response to device 102 based on the content determined from the features.

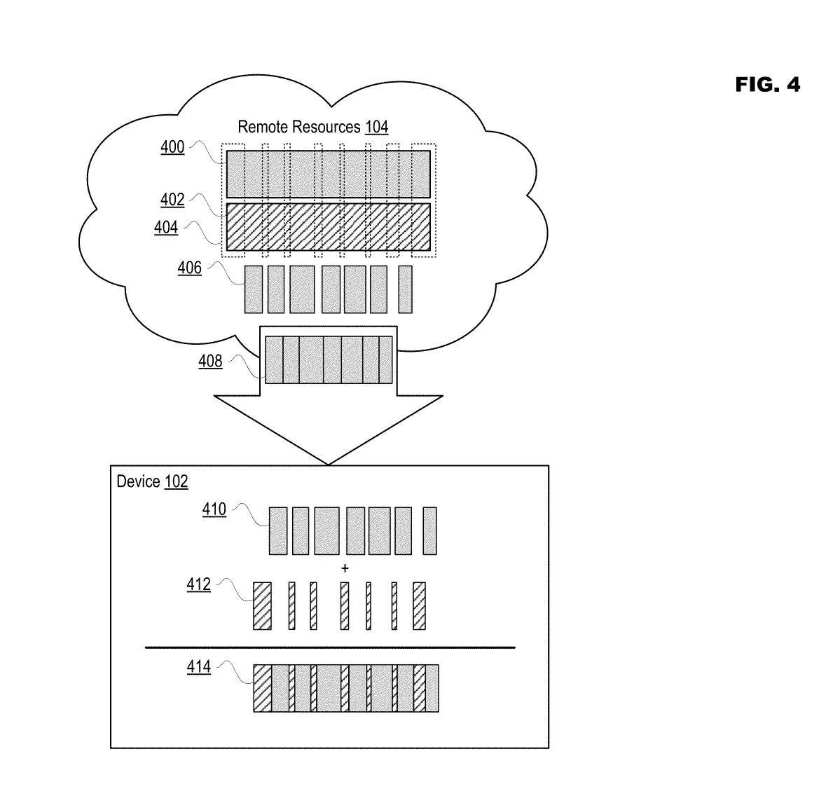

FIG. 4 illustrates an example of smart compression based on content recycling in accordance with at least one embodiment of the present disclosure. In general, remote resources 104 may attempt to determine if any portions of content in data other than that being requested by device 102 are identical or similar to portions of content in data that is being requested by device 102. If any commonality is determined between the requested data and other data, then a secondary determination may be made as to whether any of the other data is already stored in device 102. Information about other data already stored on device 102 may be available to remote resources 104 as the result of, for example, querying device 102 for a list of other data already existing in the device, a catalog of data previously provided to device 102 from remote resources 104, etc. The presence of any of the other data in device 102 may allow for content recycling, wherein only “new” portions of data (e.g., data not already existing in device 102) are transmitted, while the identical or similar content is recycled from the other data already in device 102. Operating in this manner allows for compression at a much higher ratio than in existing compression schemes.

Initially, examples of content include, but are not limited to, audio information such as music, concerts, speeches, lectures, radio programs, audio coverage of special events, etc., and images/video information such as television programs, movies, presentations, speeches, video coverage of special events, etc. An example of requested data 400 being compared to other data 402 is illustrated in FIG. 4, wherein the identical or similar content is shown within dotted rectangles 404. For example, requested data 400 may be a particular episode of a television or radio program and other data 402 may be other episodes of the same television or radio program. Given the above examples of content, examples of identical or similar content may include commercials or other messages commonly presented during audio/video content, a standard opening or closing to a program, common backdrops, commonly reused sequences or scenes, etc. The resolution of this comparison may be down to identical or similar frames being detected between requested data 400 and other data 402. At 406 the data containing “new” content (e.g., content that may not already be stored on device 102) is collected from requested data 400, and the remaining data is compressed at 408 prior to transmission to device 102. The ratio of data compression may depend on, for example, the amount of commonality (e.g., identical or similar portions) found between data 400 and 402. In one embodiment, compressed data 408 may be compressed even further using existing techniques for data compression as known in the art.

After receiving compressed data 408, smart codec 108 in device 102 may be able to separate the compressed data back into portions as shown at 410 and determine the identical or similar portions of content in data already existing on device 102 as shown at 412. The two sets of data may then be combined at 414 to create data equivalent to requested data 400. The manipulation of data shown at 410 and 412 may be based on, for example, information generated during smart compression. For example, remote resources 104 may generate assembly information or another type of data to indicate the portions of data already on device 102 that need to be combined with compressed data 410 to arrive at requested data 400. For example, information generated during smart compression may indicate that frames XXX-YYY from data ZZZ already stored in device 102 should be inserted into compressed data 410 at one or more places to decompress the data.

In an alternative implementation usable alone or in conjunction with example disclosed in FIG. 4, during compression remote resources 104 may generate “change information” instead of compressing the new content at 406-408. For example, remote resources 104 may not only determine differences between requested data 400 and other data 402, but may also determine how other data 402 may be altered to resemble the content of requested data 400. Alterations may identify features in images or video (e.g., frames) and may determine how these features may be changed to resemble the content of the requested data. Example changes may include repositioning the features, changing colors, size, text, etc. Changes may even resolve down to the pixel level, wherein certain pixels may be added, removed, repositioned, etc. In at least one embodiment, the change information may comprise at least instructions for altering data already residing within device 102. After generation, the change information may be transmitted in lieu of actually sending the requested data, the change information being of substantially smaller size than had remote resources 104 actually sent all of the requested data. The change information may then be employed in making alterations to data already stored on device 102 so that it is identical or similar to the requested data. Alternatively, in certain situations the transmission of change information may be utilized in conjunction with the transmission of new data as disclosed in FIG. 4. For example, it may not be efficient to alter some portions of the data already existing in device 102 to resemble the requested data, and thus, new portions of data may be substituted.

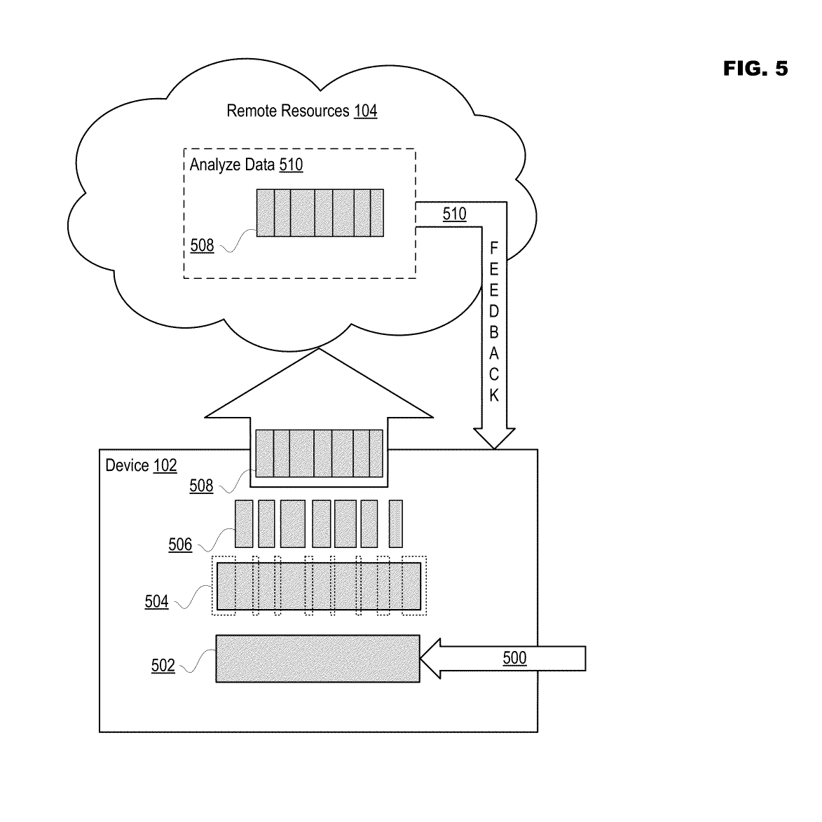

FIG. 5 illustrates an example of smart compression based on feature identification in accordance with at least one embodiment of the present disclosure. An example application to which the operations disclosed in FIG. 5 may be applied is mobile augmented reality. In mobile augmented reality, a device may capture an image or video of a location that may be displayed on the device and supplemented with additional information that may be beneficial to the user. For example, an image of a street may be supplemented with overlays identifying restaurants on the street, reviews of the restaurants, directions to certain street locations, etc. However, while mobile augmented reality is used in FIG. 5 as an example to describe embodiments consistent with the present disclosure, these operations are not limited only to use with this application.

Initially, device 102 may capture information as shown at 500. For example, captured information 502 may include at least one of images or video captured by a camera in device 102. In existing systems all of the captured information is transmitted to remote resources 104, which may necessitate the transmission of a substantial amount of data even after existing compression schemes are applied. Instead, in smart compression only certain features 504 of information 502 may be transmitted, which entails substantially less data. Examples of features 504 that may be captured include, but are not limited to, indicia of location (e.g., street signs), structural features, colors/patterns/textures, relative locations of visually distinctive objects (e.g., windows, doors, awnings, roofs, etc.), light/dark differential, etc. Features 504 of information 502 may then be compressed as illustrated 506 and transmitted to remote resource 104 as shown at 508. In one embodiment, compressed data 508 may be compressed even further using existing techniques for data compression as known in the art.

Remote resources 104 may then analyze compressed data 508 as shown at 510. In the example disclosed in FIG. 5, the analysis may be performed by an augmented reality module. The augmented reality module may be able to determine content for information 502 captured by device 102. Moreover, based on the determined content, remote resources 104 may provide feedback 510 to device 102. Using a mobile augmented reality application as an example usage scenario, captured information 502 may include a street, buildings, etc. Features 504 included in compressed data 508 may be analyzed by remote resources 104, as shown at 510, to identify the street, buildings, etc. in captured image 502. Remote resources 104 may then provide feedback 510 to device 102 regarding the determined street, buildings, etc., the feedback including, for example, context information regarding the street, buildings, etc. such as retail establishments in the buildings, ratings for retail establishments in the buildings, directions to other locations, etc.

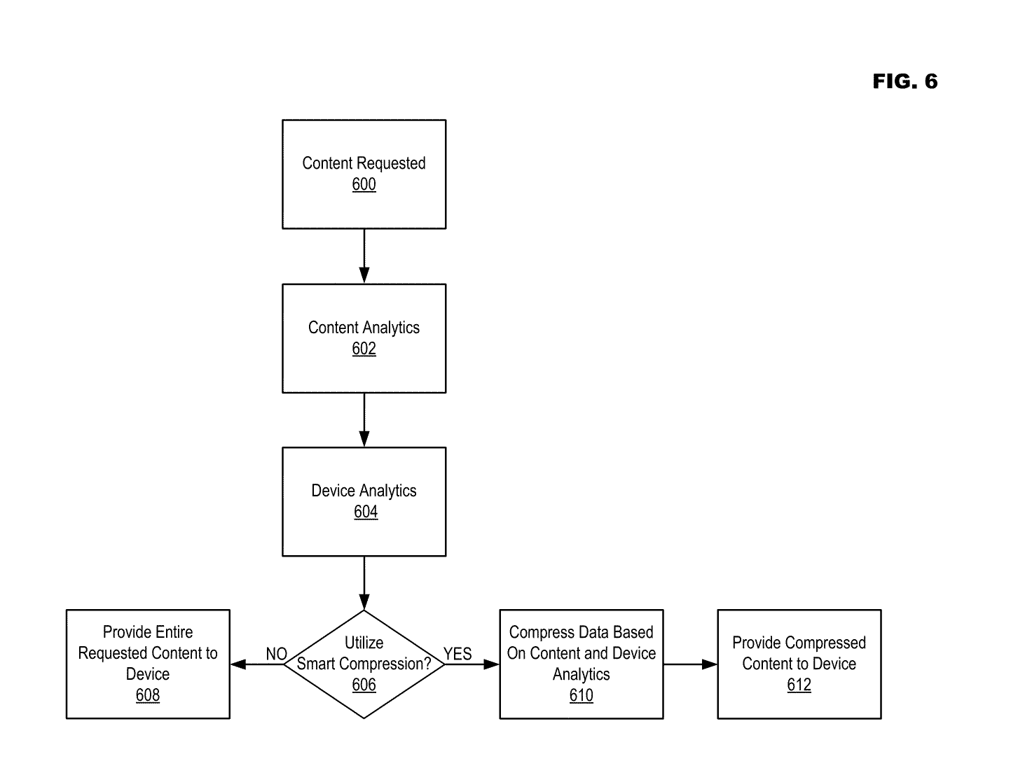

FIG. 6 illustrates example operations for a dynamic data compression system based on content recycling in accordance with at least one embodiment of the present disclosure. In operation 600, a device may request data comprising certain content from remote resources. Content analytics may then be performed in operation 602. Content analytics may comprise, for example, determining whether any portions of content in the requested data are identical or similar to any portions of content in other data. Content analytics in operation 602 may be followed by device analytics in operation 604. In one embodiment, device analytics 602 may initially analyze the capabilities and/or condition of the requesting device. The capabilities of the requesting device may include, for example, whether smart compression is even supported by the requesting device. The condition of the requesting device may include, for example, the processing load of the requesting device, the communication load of the requesting device, the power level of the requesting device, etc. Moreover, device analytics 604 may involve determining whether any of the other data determined to comprise portions of content identical or similar to any portions of the content in the requested data is already stored on the device. This information may be available to the remote resources by querying the device, through a catalog of previously downloaded data, etc.

In operation 606 a determination may then be made as to whether smart compression should be used to compress the requested data. Referring to the analysis performed in operations 602 and 604, smart compression may not be employed if, for example, smart compression is not supported by the device, if the device does not have adequate resources to support the additional processing load required for smart compression, if no other data comprising portions of content identical or similar to portions of the requested content was determined to be already stored on the device, etc. If in operation 606 it is determined that smart compression should not be utilized, then in operation 608 the entirety of the requested content may be provided to the device. If in operation 606 it is determined that smart compression should be utilized, then in operation 610 the data may be compressed based on the content and device analytics. For example, portions of content in the requested data that were determined to not already be stored in device 100 (e.g., “new” content) may be selected, compressed, and then transmitted to the device in operation 612.

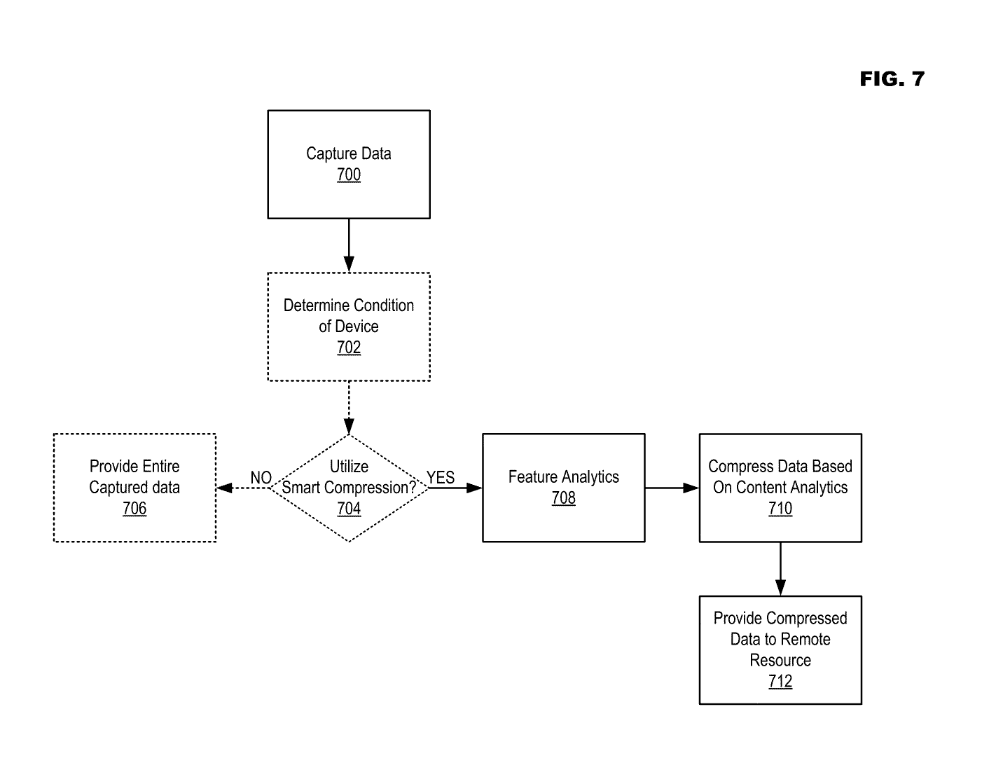

FIG. 7 illustrates example operations for a dynamic data compression system based on feature identification in accordance with at least one embodiment of the present disclosure. In operation 700 data may be captured by a device. For example, a device may capture at least one of image or video data via a camera in the device. Operations 702 to 706 may be optional in that their use may be application specific. For example, the inclusion of operations 702 to 706 may be dependent upon, for example, device capability, whether the device resource limitations (e.g., is a mobile device), etc. In operation 702 the condition of the device may be determined. For example, device condition may include processing load, communication load, power level, etc.

In operation 706 a determination may then be made as to whether to utilize smart compression based on, for example, the determined condition of the device. If in operation 704 it is determined that smart compression should not be utilized (e.g., due to limited resources being available in the device), then in operation 706 the entirety of the captured data may be provided to a remote resource for processing. If in operation 704 it is determined that smart compression should be employed, then in operation 708 feature analytics may be performed. For example, certain features may be extracted from the captured data that may be indicative of the content of the captured. Smart compression may then occur in operation 710 wherein the extracted features are then collected for transmission to the remote resource in operation 712.

While FIGS. 6 and 7 illustrates operations according to an embodiment, it is to be understood that not all of the operations depicted in FIGS. 6 and 7 are necessary for other embodiments. Indeed, it is fully contemplated herein that in other embodiments of the present disclosure, the operations depicted in FIGS. 6 and 7, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, this disclosure is directed to a dynamic data compression system. A device may request data comprising certain content from a remote resource. The remote resource may determine if any part of the content is identical or similar to content in other data and if the other data is already on the requesting device. Smart compression may then involve transmitting only the portions of the content not residing on the requesting device, which may combine the received portions of the content with the other data. In another example, a capturing device may capture at least one of an image or video. Smart compression may then involve transmitting only certain features of the image/video to the remote resource. The remote resource may determine image/video content based on the received features, and may perform an action based on the content. In addition, a determination whether to perform smart compression may be based on system/device conditions.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a dynamic data compression system, as provided below.

### Example 1

According to this example there is provided at least one device. The at least one device may include a content analytics module to receive a request for data including certain content from a device and to analyze the content of the data, a device analytics module to analyze characteristics of the requesting device based at least on the content analysis performed by the content analytics module, a smart compression/decompression (codec) module to at least compress the data based at least on the analysis performed by the client analytics module and a communication module to transmit the compressed data to the requesting device.

### Example 2

This example includes the elements of example 1, wherein the at least one device comprises a plurality of computing devices to operate as a cloud resource accessible via a wide area network (WAN).

### Example 3

This example includes the elements of example 2, wherein the plurality of computing devices are servers, at least one the plurality of servers being to store the requested data including certain content.

### Example 4

This example includes the elements of any of examples 1 to 3, wherein the requesting device comprises at least a smart codec compatible with the smart codec in the at least one device.

### Example 5

This example includes the elements of any of examples 1 to 4, wherein the content analytics module being to analyze the content of the data requested by the device comprises the content analytics module being to determine if any portion of the content is identical or similar to any portion of content in other data.

### Example 6

This example includes the elements of example 5, wherein the device analytics module being to analyze the characteristics of the requesting device comprises the device analytics module being to, if it is determined that a portion of the content is identical or similar to any portion of content in other data, determine if the requesting device is able to support smart compression.

### Example 7

This example includes the elements of example 6, wherein the device analytics module being to determine if the requesting device is able to perform smart compression comprises the device analytics module being to determine at least one of capability or condition for the requesting device.

### Example 8

This example includes the elements of any of examples 5 to 7, wherein the device analytics module being to analyze the characteristics of the requesting device comprises the device analytics module being to track other data already present on the requesting device.

### Example 9

This example includes the elements of any of examples 5 to 8, wherein the device analytics module being to analyze the characteristics of the requesting device comprises the device analytics module being to determine if the other data determined to contain any portion of identical or similar content is already present on the requesting device.

### Example 10

This example includes the elements of example 9, wherein the smart codec module being to at least compress the data comprises the smart codec module being to remove any portion of content from the data that was determined to be identical or similar to any portion of content in the other data determined to be already present in the requesting device.

### Example 11

This example includes the elements of any of examples 9 to 10, wherein the smart codec module being to at least compress the data comprises the smart codec module being to generate change information allowing the requesting device to alter the content of the other data determined to be already present in the requesting device to be identical or similar to the content of the data.

### Example 12

This example includes the elements of example 11, wherein the change information comprises at least instructions for altering other content already present in the requesting device.

### Example 13

This example includes the elements of any of examples 1 to 12, wherein the smart codec is further to receive compressed data from a capturing device, the compressed data including features derived from at least one of images or video captured by the capturing device.

### Example 14

This example includes the elements of example 13, wherein the smart codec is further to determine content for the at least one of images or video based on the features.

### Example 15

This example includes the elements of example 14, further comprising an augmented reality module to provide context information to the capturing device based on the content.

### Example 16

This example includes the elements of example 15, wherein the context information comprises descriptive information corresponding to at least one of the features.

### Example 17

According to this example there is provided a device. The device may include a user interface module to cause at least one of images or video to be captured, a smart codec to generate compressed data by deriving features from the at least one of images or video, the compressed data including at least the derived features and a communication module to transmit the compressed data to remote resources.

### Example 18

This example includes the elements of example 17, wherein the smart codec module is further to determine device condition and determine whether to use smart compression based on the device condition.

### Example 19

This example includes the elements of any of examples 17 to 18, wherein the communication module is further to receive context information from the remote resources, the context information corresponding to the at least one of images or video.

### Example 20

This example includes the elements of example 18, wherein the user interface module is further to display the received context information superimposed over a display of the at least one of images or video.

### Example 21

According to this example there is provided a method. The method may include receiving a request for data including certain content from a device, performing analysis on the content of the data, performing analysis on the requesting device based at least on the content analysis, determining whether to use smart compression based at least on the device analysis, compressing the data based on at least on the determination whether to use smart compression and the device analysis and transmitting the compressed data to the requesting device.

### Example 22

This example includes the elements of example 21, wherein performing analysis on the content of the data comprises determining if any portion of the content is identical or similar to any portion of content in other data.

### Example 23

This example includes the elements of example 22, wherein performing analysis on the requesting device comprises tracking the other data already present on the requesting device.

### Example 24

This example includes the elements of example 23, wherein performing analysis on the requesting device comprises determining if the other data determined to contain any portion of identical or similar content is already present in the requesting device.

### Example 25

This example includes the elements of any of examples 22 to 24, wherein if it is determined to use smart compression, compressing the data comprises removing any portion of content from the data that was determined to be identical or similar to any portion of content in the other data determined to be already present on the requesting device.

### Example 26

This example includes the elements of example 25, wherein if it is determined to use smart compression, compressing the data comprises generating change information allowing the requesting device to alter the content of the other data determined to be already present in the requesting device to be identical or similar to the content of the data.

### Example 27

This example includes the elements of any of examples 25 to 26, wherein determining whether to use smart compression comprises determining at least one of capability or condition for the requesting device.

### Example 28

This example includes the elements of any of examples 21 to 27, further comprising receiving compressed data from a capturing device, the compressed data including features derived from at least one of images or video captured by the capturing device and determining content for the at least one of images or video based on the features.

### Example 29

This example includes the elements of example 28, further comprising providing context information to the capturing device based on the content.

### Example 30

According to this example there is provided a method. The method may include capturing at least one of images or video, compressing data by deriving features from the at least one of images or video, the compressed data including at least the derived features and transmitting the compressed data to remote resources.

### Example 31

This example includes the elements of example 29, further comprising determining device condition and determining whether to use smart compression based on the device condition.

### Example 32

This example includes the elements of any of examples 29 to 30, further comprising receiving context information from the remote resources, the context information corresponding to the at least one of images or video.

### Example 33

This example includes the elements of example 32, further comprising displaying the received context information superimposed over a display of the at least one of images or video.

### Example 34

This example includes a system comprising at least one device, the system being arranged to perform the method of any of examples 21 to 33.

### Example 35

This example includes a chipset arranged to perform the method of any of examples 21 to 33.

### Example 36

This example includes at least one machine readable medium comprising a plurality of instructions that, in response to be being executed on a computing device, cause the computing device to carry out the method according to any of examples 21 to 33.

### Example 37

This example includes at least one device configured for use with a dynamic data compression system, the device being arranged to perform the method of any of examples 21 to 33.

### Example 38

This example includes at least one device having means to perform the method of any of examples 21 to 33.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. At least one device, comprising:
a content analytics module to receive a request for data including certain content from a device and to analyze the content of the data;
a device analytics module to analyze characteristics of the requesting device based at least on the content analysis performed by the content analytics module;
a smart compression/decompression (codec) module to at least compress the data based at least on the analysis performed by the client analytics module; and
a communication module to transmit the compressed data to the requesting device.

2. The at least one device of claim 1, wherein the at least one device comprises a plurality of computing devices to operate as a cloud resource accessible via a wide area network (WAN).

3. The at least one device of claim 1, wherein the content analytics module being to analyze the content of the data requested by the device comprises the content analytics module being to determine if any portion of the content is identical or similar to any portion of content in other data.

4. The at least one device of claim 3, wherein the device analytics module being to analyze the characteristics of the requesting device comprises the device analytics module being to, if it is determined that a portion of the content is identical or similar to any portion of content in other data, determine if the requesting device is able to support smart compression.

5. The at least one device of claim 4, wherein the device analytics module being to determine if the requesting device is able to perform smart compression comprises the device analytics module being to determine at least one of capability or condition for the requesting device.

6. The at least one device of claim 3, wherein the device analytics module being to analyze the characteristics of the requesting device comprises the device analytics module being to determine if the other data determined to contain any portion of identical or similar content is already present on the requesting device.

7. The at least one device of claim 6, wherein the smart codec module being to at least compress the data comprises the smart codec module being to remove any portion of content from the data that was determined to be identical or similar to any portion of content in the other data determined to be already present in the requesting device.

8. The at least one device of claim 6, wherein the smart codec module being to at least compress the data comprises the smart codec module being to generate change information allowing the requesting device to alter the content of the other data determined to be already present in the requesting device to be identical or similar to the content of the data.

9. The at least one device of claim 1, wherein the smart codec is further to receive compressed data from a capturing device, the compressed data including features derived from at least one of images or video captured by the capturing device.

10. The at least one device of claim 9, wherein the smart codec is further to determine content for the at least one of images or video based on the features.

11. The at least one device of claim 10, further comprising an augmented reality module to provide context information to the capturing device based on the content.

12. A method, comprising:
receiving a request for data including certain content from a device;
performing analysis on the content of the data;
performing analysis on the requesting device based at least on the content analysis;
determining whether to use smart compression based at least on the device analysis;
compressing the data based on at least on the determination whether to use smart compression and the device analysis; and
transmitting the compressed data to the requesting device.

13. The method of claim 12, wherein performing analysis on the content of the data comprises determining if any portion of the content is identical or similar to any portion of content in other data.

14. The method of claim 13, wherein performing analysis on the requesting device comprises:
tracking the other data already present on the requesting device; and
determining if the other data determined to contain any portion of identical or similar content is already present in the requesting device.

15. The method of claim 14, wherein if it is determined to use smart compression, compressing the data comprises removing any portion of content from the data that was determined to be identical or similar to any portion of content in the other data determined to be already present on the requesting device.

16. The method of claim 14, wherein if it is determined to use smart compression, compressing the data comprises generating change information allowing the requesting device to alter the content of the other data determined to be already present in the requesting device to be identical or similar to the content of the data.

17. The method of claim 12, wherein determining whether to use smart compression comprises determining at least one of capability or condition for the requesting device.

18. The method of claim 12, further comprising:
receiving compressed data from a capturing device, the compressed data including features derived from at least one of images or video captured by the capturing device;
determining content for the at least one of images or video based on the features; and
providing context information to the capturing device based on the content.

19. At least one machine-readable storage medium having stored thereon, individually or in combination, instructions that when executed by one or more processors result in the following operations comprising:
receiving a request for data including certain content from a device;
performing analysis on the content of the data;
performing analysis on the requesting device based at least on the content analysis;
determining whether to use smart compression based at least on the device analysis;
compressing the data based on at least on the determination whether to use smart compression and the device analysis; and
transmitting the compressed data to the requesting device.

20. The medium of claim 19, wherein performing analysis on the content of the data comprises determining if any portion of the content is identical or similar to any portion of content in other data.

21. The medium of claim 20, wherein performing analysis on the requesting device comprises:
tracking the other data already present on the requesting device; and
determining if the other data determined to contain any portion of identical or similar content is already present in the requesting device.

22. The medium of claim 21, wherein if it is determined to use smart compression, compressing the data comprises removing any portion of content from the data that was determined to be identical or similar to any portion of content in the other data determined to be already present on the requesting device.

23. The method of claim 21, wherein if it is determined to use smart compression, compressing the data comprises generating change information allowing the requesting device to alter the content of the other data determined to be already present in the requesting device to be identical or similar to the content of the data.

24. The medium of claim 19, wherein determining whether to use smart compression comprises determining at least one of capability or condition for the requesting device.

25. The medium of claim 19, further comprising instructions that when executed by one or more processors result in the following operations comprising:
receiving compressed data from a capturing device, the compressed data including features derived from at least one of images or video captured by the capturing device;
determining content for the at least one of images or video based on the features; and
providing context information to the capturing device based on the content.
